(19) United States
(12) Patent Application Publication
(10) Pub. No.: US 2005/0247830 A1
(43) Pub. Date: Nov. 10, 2005

(54) Pivoting keyboard and mouse tray

(76) Inventor: Alfred P. Rossini, Southborough, MA (US)

Correspondence Address: BRIAN M. DINGMAN;MIRICK, O'CONNELL, DEMALLIE & LOUGEE, LLP, 100 FRONT STREET, WORCESTER, MA, 01608, US

(21) Appl. No.: 11/122,975

(22) Filed: May 5, 2005

Related U.S. Application Data
(60) Provisional application No. 60/568,278, filed on May 5, 2004.

(51) Int. Cl. B68G 5/00

(52) U.S. Cl. 248/118.3

(57) ABSTRACT

A pivoting keyboard and mouse tray for attachment to a support structure such as a mobile computer cart. The device includes a keyboard tray adapted to hold a keyboard, a mechanical structure for coupling the keyboard tray to the support structure, one or more hinges between the keyboard tray and the mechanical structure to allow the keyboard tray to be pivoted relative to the support structure and maintain the keyboard tray in the pivoted position, and one or more mouse trays integral with or coupled to the keyboard tray.

### CROSS REFERENCE TO RELATED APPLICATION

This application claims priority of Provisional application Ser. No. 60/568,278, filed on May 5, 2004.

### FIELD OF THE INVENTION

This invention relates to a keyboard and mouse tray.

### BACKGROUND OF THE INVENTION

Mobile carts used as workstations are known. These carts are commonly used in medical facilities and on manufacturing floors. They are typically adapted to carry a computer, and usually have additional shelf space available for the user, for such things as paper work, medications, and/or portable medical equipment. They also may in some cases include a tray that holds a computer keyboard. However, the trays are fixed in both height and angle, thus making them awkward for some users. A more ergonomic design is needed.

### SUMMARY OF THE INVENTION

This invention comprises a pivoting tray that holds a keyboard. Retractable, hideaway pivoting extensions on the left- and right-hand sides of the tray hold a mouse-type computer input device. The inventive tray typically is attached to a mobile computer cart that offers a portable computer workstation solution for professionals as well as retail and home use.

This invention features a pivoting keyboard and mouse tray for attachment to a support structure, comprising a keyboard tray adapted to hold a keyboard, a mechanical structure for coupling the keyboard tray to the support structure, one or more hinges between the keyboard tray and such mechanical structure to allow the keyboard tray to be pivoted relative to the support structure and maintain the keyboard tray in the pivoted position, and one or more mouse trays integral with or coupled to the keyboard tray. The hinges may be torque hinges. There may be a plurality of collinear torque hinges. The mechanical structure for coupling the keyboard tray to the support structure may comprise an arm. The arm may comprise flanges on one end for coupling the arm to the support structure. The arm may be generally “L” shaped, with a surface for coupling to the keyboard tray at the distal end of the arm opposite the flanges. One or more hinges may be mounted to the distal end of the arm.

The mouse tray is preferably pivotably coupled to the keyboard tray. The pivoting keyboard and mouse tray may in this case further comprise mechanical structure for guiding the mouse tray in a pivoting path relative to the keyboard tray. The mechanical structure may comprise an arc-shaped slot in one of the keyboard tray and the mouse tray, and a pin that passes through the slot on the other of the keyboard tray and the mouse tray. There may be two mouse trays, one coupled to each end of the keyboard tray, and both coupled in the same pivoting manner. The mouse tray may also comprise a mechanical structure that assists in maintaining a mouse on the mouse tray as the keyboard tray is pivoted, which may comprises an arm proximate the back of the tray, and a tab projecting up from the back of the mouse tray proximate the arm.

This invention also features a pivoting keyboard and mouse tray for attachment to a support structure, comprising a keyboard tray adapted to hold a keyboard, an arm coupled at one end to the support structure at the other end to the keyboard tray, a plurality of torque hinges between the keyboard tray the arm to allow the keyboard tray to be pivoted relative to the arm, and maintain the keyboard tray in the pivoted position, and one or more mouse trays pivotably coupled to the keyboard tray. The arm is preferably generally “L” shaped, with a surface for coupling to the keyboard tray at the distal end of the arm opposite the flanges. The pivoting keyboard and mouse tray may further comprise mechanical structure for guiding each mouse tray in a pivoting path relative to the keyboard tray, which may be accomplished with an arc-shaped slot in one of the keyboard tray and the mouse tray, and a pin that passes through the slot on the other of the keyboard tray and the mouse tray. The mouse trays may each comprise a mechanical structure that assists in maintaining a mouse on the mouse tray as the keyboard tray is pivoted, which may be accomplished with an arm proximate the back of the tray.

### BRIEF DESCRIPTION OF THE DRAWINGS

Other objects, features and advantages will occur to those skilled in the art from the following description of the preferred embodiments and the accompanying drawings, in which:

FIG. 1 is a partially disassembled view of the preferred embodiment of the pivoting keyboard and mouse tray of the invention;

FIG. 2 is a cross-sectional diagram of the assembled pivoting keyboard and mouse tray of FIG. 1;

FIG. 3 is a bottom view of the pivoting keyboard and mouse tray of FIG. 1;

FIG. 4 shows the pivoting keyboard and mouse tray of FIG. 1 mounted to a mobile computer cart; and

FIG. 5 is schematic, partially cross-sectional drawing of a mouse-retaining pocket for an alternative embodiment of the invention.

### DESCRIPTION OF THE PREFERRED EMBODIMENTS OF THE INVENTION

This invention may be accomplished in a pivoting keyboard and mouse tray for attachment to a support structure such as a mobile computer cart. The inventive device can be made of steel or aluminum, for example, and preferably includes a keyboard tray adapted to hold a keyboard, a mechanical structure such as an arm for coupling the keyboard tray to the support structure; one or more hinges between the keyboard tray and the mechanical structure to allow the keyboard tray to be pivoted relative to the support structure and maintain the keyboard tray in the pivoted position, and one or more mouse trays integral with or coupled to the keyboard tray.

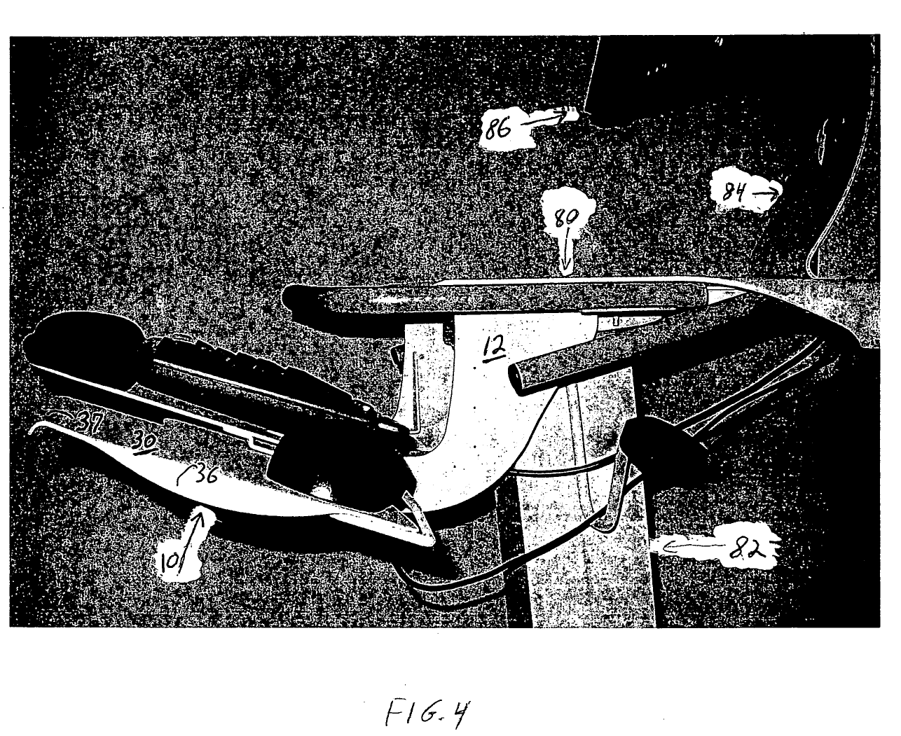

Pivoting keyboard and mouse tray 10 comprises tray support arm 12, keyboard tray 20, right retractable mouse plate 30, and mirror image left retractable mouse plate 40. Keyboard tray 20 defines upper surface 22 that is sized and shaped to hold a standard keyboard input device and preferably a wrist rest pad. Lower standoff extension 24 provides a surface to which collinear hinges 18 can be mounted without interfering with surface 22. In the preferred embodiment, hinges 18 are torque hinges such as #D 200918 from Reell Precision Manufacturing of St. Paul, Minn. These hinges have enough resistance to maintain the position of the keyboard and mouse plates. Hinges 18 are mounted to the bottom surface of extension 24 and the end face 16 of generally “L”-shaped arm 12. The other end 14 of arm 12 in this embodiment comprises a flange that is adapted to be mounted to the underside of the upper work surface of a laptop computer tray of a mobile computer cart. This is shown is shown in FIG. 4, in which arm 12 is mounted to the underside of work surface 80 of the mobile computer cart that also comprises adjustable-height post 82 and bracket 84 that holds monitor or tablet computer 86 off of surface 80. An example of an appropriate mobile computer cart on which the inventive tray can be used can be found in U.S. patent application Ser. No. 10/923,638 filed on Aug. 20, 2004, which is incorporated herein by reference.

Hinges 18 allow the positioning of keyboard tray 20 along the entire range of motion of the hinges—in this case from a substantially vertical downward position of tray 20 (in which the keyboard and mouse are out of the way of the user), all the way up through a range of motion beyond horizontal, as shown in FIG. 4. This allows the user to adjust the angle of the keyboard as appropriate depending on the user's position, so that the user can maintain a comfortable position and angle of the keyboard relative to the user's arms. This allows the mobile computer cart to be used by people of different heights in both the seated and standing position. As the mouse plates are attached to the keyboard tray, the mouse is maintained at essentially the same height and in essentially the same plane as the keyboard. This prevents the user from having to bend the wrist at an awkward angle in order to use the mouse.

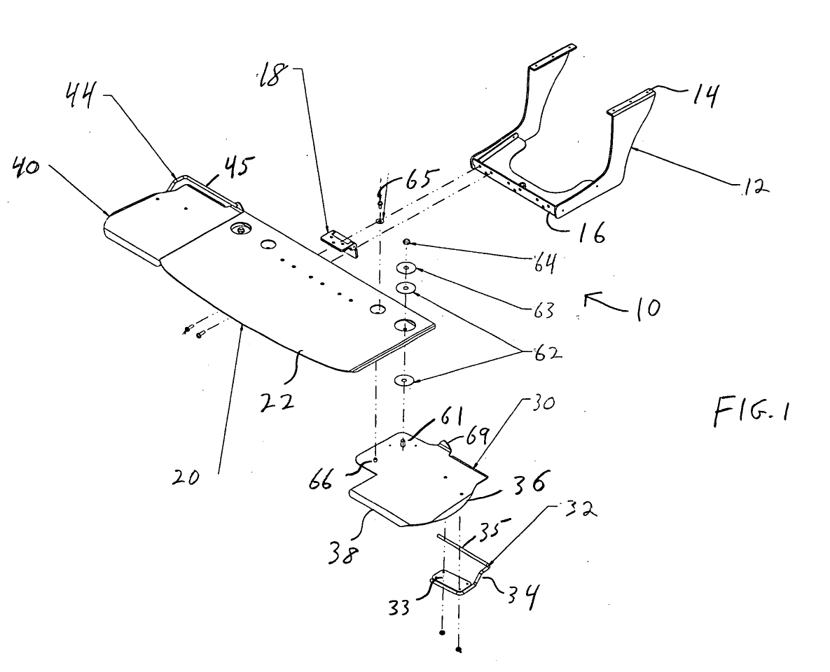

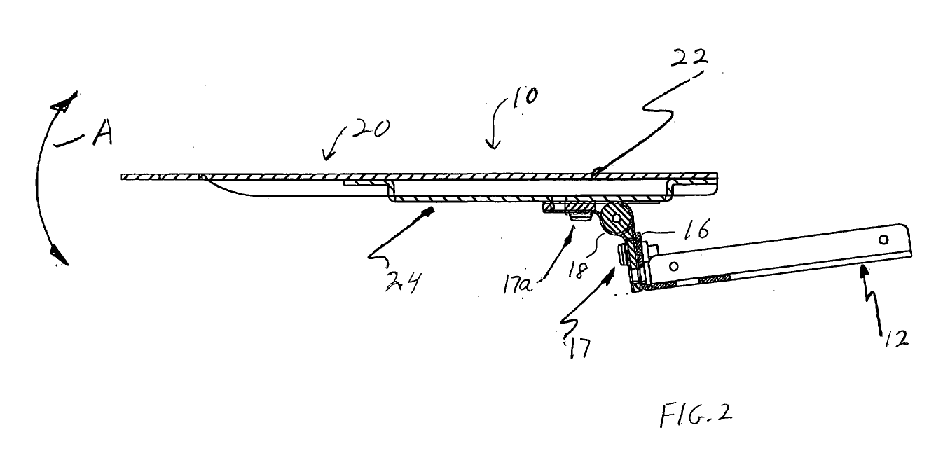

The right and left mouse plates operate identically. As best seen in FIGS. 1 and 2, right mouse plate 30 is adapted to pivot about projection 61, which can be a bolt and lock nut combination 64, with intermediate washers 62 and 63 that are sandwiched against standoff 24. Extended and retracted positions of the mouse plates are defined by contact of the protruding pin or standoff 66 with the ends of crescent shaped slot 31 formed in lower member 24 in which standoff 66 rides. Standoff 66 can be internally threaded and accept screw 65. The head of the screw rides along the top of slot 31. Screw 65 thus also helps to support the mouse plate in the extended position. Handle 37 provides a grasping point to allow the user to pivot the mouse plate between the extended position such as shown with plate 40, FIG. 2, and a retracted position (not shown in the drawings) in which the plate is stowed under tray 22.

As the mouse trays can be tilted in both directions from the horizontal, it is helpful to include a mechanical structure to maintain the mouse on the mouse plate, while not interfering with the use of the mouse. Front and outside mouse plate edges 38 and 36, respectively, are turned down so that the edges do not interfere with the user's hand. Rear mouse catch rod assembly 32 is attached to mouse plate 30 by screwing the attachment plate 33 to the underside of plate 30. Rod 34 includes extending distal portion 35 that provides a stop at the rear side of the mouse plate, as shown with mirror image rod 45 of left mouse plate 40. This provides some height at the back of the plate so that the mouse does not slide off the back of the plate when the tray is tilted up from the horizontal. In order to help prevent the mouse from sliding off the front of the tray when the tray is pivoted down from the horizontal, rearward upwardly projecting tab 69 is configured to provide a gap between tab 69 and rod distal portion 35, through which the mouse cable can be fitted. This fit helps to prevent the cable from sliding out past the distal end 35 of rod 34, so that the cable stays between rod 34 and plate 30. In this manner, even if the mouse slides off the front 38 or side 36 of plate 30, the cable prevents the mouse from falling to the floor, and the user can grasp the mouse and place it back on plate 30.

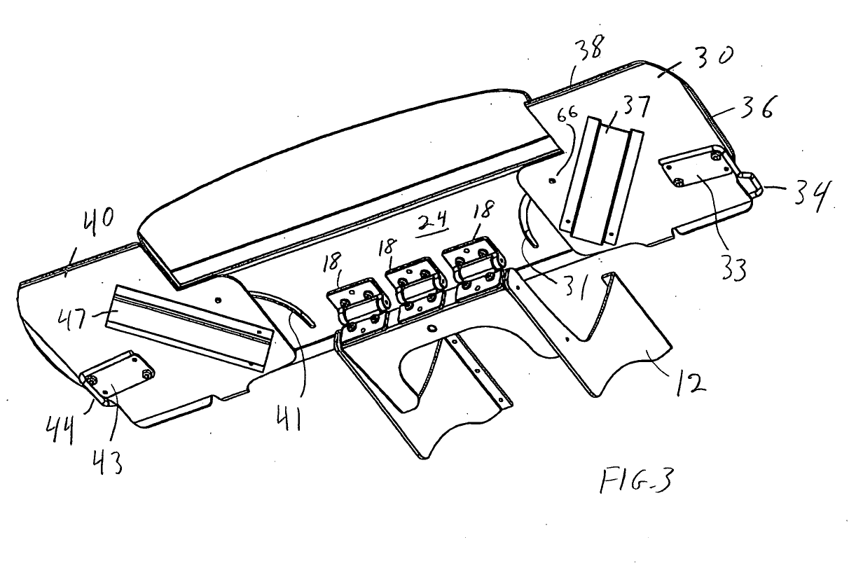

Left mouse plate 40 includes handle 47, and attachment plate 34 that carries mouse-retaining rod 34. Slot 41, which mirrors slot 31, is also shown in FIG. 3.

There are alternative means of accomplishing the pivoting keyboard and mouse tray of this invention. For example, there could only be a single mouse plate. The one or two mouse plates need not be retractable relative to the keyboard plate. In fact, the keyboard and mouse trays could be accomplished with a single plate that was sufficiently wide to accommodate a keyboard and mouse. The tray pivot hinge or hinges could be attached directly to the computer cart, without the intermediate tray support arm. Further, the pivoting motion could be accomplished by other means such as a single piano-type hinge, as well as adjustable in-line constant torque hinges that allow an angle to be set and held.

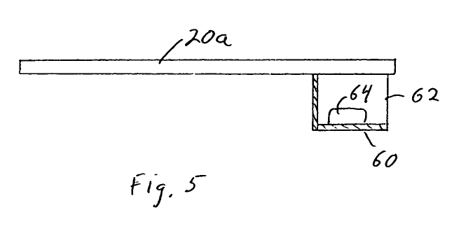

Another alternative would be to include a mechanical construction that would store the mouse when the mouse surface is pivoted inward to its stowed position. This could be accomplished with a pocket formed of sheet metal and attached to the bottom of the keyboard or mouse surface. One example is shown in FIG. 5, in which pocket 60 attached to the underside of tray 20a has open side 62 into which mouse 64 can be inserted so that the mouse is retained as the tray is moved.

The inventive tray and the cart to which the tray is preferably mounted may be constructed primarily of aluminum and/or cold rolled steel sheet metal. The metal is processed through turret punch machines and lasers to produce the shapes needed. The metal is formed in press brake machines and then a powder coat finish is applied. The finished parts are assembled and tested before shipping. The cart is designed to be used with a variety of computing solutions such as, but not limited to, standard desktop or laptop computers, thin client computers, and all-in-one flat screen computer systems. All computers can be secured to the mobile cart by either a locking cover surface that can be secured by a padlock, or a wrap cable that will prevent removal of the computer while engaged, and in which access to the cable release mechanism is blocked by a padlock.

A computer security device is preferably included. The particular device employed varies depending on the type of computer system that is installed on the cart. For example, a universal CPU holder (typically mounted to the base of the cart, but which can be located where desired) can be used to securely hold thin client and full function CPUs of desktop computer models. The computer can be locked into position on the CPU holder with a nylon coated steel braided wire that crosses over the top of the PC and is held tightly in place with a hold down screw; access to this hold down screw is blocked by inserting a padlock through a structure in front of the hold down screw. To remove the computer, the padlock must be removed, and then the hold down screw loosened, which allows the cable to be loosened and the PC to be removed. Other locking arrangements are possible.

Although specific features of the invention are shown in some drawings and not others, this is for convenience only, as the features can be combined as would be apparent to those skilled in the art, and as the claims set forth the rights granted under the patent. Other combinations of features will be apparent to those skilled in the art and are within the scope of the claims.

1. A pivoting keyboard and mouse tray for attachment to a support structure, comprising:
a keyboard tray adapted to hold a keyboard;
a mechanical structure for coupling the keyboard tray to the support structure;
one or more hinges between the keyboard tray and such mechanical structure to allow the keyboard tray to be pivoted relative to the support structure and maintain the keyboard tray in the pivoted position; and
one or more mouse trays integral with or coupled to the keyboard tray.

2. The pivoting keyboard and mouse tray of claim 1 wherein the hinges comprise torque hinges.

3. The pivoting keyboard and mouse tray of claim 2 wherein there are a plurality of collinear torque hinges.

4. The pivoting keyboard and mouse tray of claim 1 wherein the mechanical structure for coupling the keyboard tray to the support structure comprises an arm.

5. The pivoting keyboard and mouse tray of claim 4 wherein the arm comprises flanges on one end for coupling the arm to the support structure.

6. The pivoting keyboard and mouse tray of claim 5 wherein the arm is generally “L” shaped, with a surface for coupling to the keyboard tray at the distal end of the arm opposite the flanges.

7. The pivoting keyboard and mouse tray of claim 6 wherein the one or more hinges are mounted to the distal end of the arm.

8. The pivoting keyboard and mouse tray of claim 1 wherein at least one mouse tray is pivotably coupled to the keyboard tray.

9. The pivoting keyboard and mouse tray of claim 8 further comprising mechanical structure for guiding the mouse tray in a pivoting path relative to the keyboard tray.

10. The pivoting keyboard and mouse tray of claim 9 wherein the mechanical structure comprises an arc-shaped slot in one of the keyboard tray and the mouse tray, and a pin that passes through the slot on the other of the keyboard tray and the mouse tray.

11. The pivoting keyboard and mouse tray of claim 10 wherein there are two mouse trays, one coupled to each end of the keyboard tray, and both coupled in the same pivoting manner.

12. The pivoting keyboard and mouse tray of claim 1 wherein the mouse tray comprises a mechanical structure that assists in maintaining a mouse on the mouse tray as the keyboard tray is pivoted.

13. The pivoting keyboard and mouse tray of claim 12 wherein the mechanical structure that assists in maintaining a mouse on the mouse tray as the keyboard tray is pivoted comprises an arm proximate the back of the tray.

14. The pivoting keyboard and mouse tray of claim 13 wherein the mechanical structure that assists in maintaining a mouse on the mouse tray as the keyboard tray is pivoted further comprises a tab projecting up from the back of the mouse tray proximate the arm.

15. A pivoting keyboard and mouse tray for attachment to a support structure, comprising:
a keyboard tray adapted to hold a keyboard;
an arm coupled at one end to the support structure at the other end to the keyboard tray;
a plurality of torque hinges between the keyboard tray the arm to allow the keyboard tray to be pivoted relative to the arm, and maintain the keyboard tray in the pivoted position; and
one or more mouse trays pivotably coupled to the keyboard tray.

16. The pivoting keyboard and mouse tray of claim 15 wherein the arm is generally “L” shaped, with a surface for coupling to the keyboard tray at the distal end of the arm opposite the flanges.

17. The pivoting keyboard and mouse tray of claim 15 further comprising mechanical structure for guiding each mouse tray in a pivoting path relative to the keyboard tray.

18. The pivoting keyboard and mouse tray of claim 17 wherein the mechanical structure comprises an arc-shaped slot in one of the keyboard tray and the mouse tray, and a pin that passes through the slot on the other of the keyboard tray and the mouse tray.

19. The pivoting keyboard and mouse tray of claim 15 wherein the mouse trays each comprise a mechanical structure that assists in maintaining a mouse on the mouse tray as the keyboard tray is pivoted.

20. The pivoting keyboard and mouse tray of claim 19 wherein the mechanical structure that assists in maintaining a mouse on the mouse tray as the keyboard tray is pivoted comprises an arm proximate the back of the tray.
